(19) United States
(12) Patent Application Publication
(10) Pub. No.: US 2021/0065553 A1
(43) Pub. Date: Mar. 4, 2021

(54) INFORMATION PROCESSING DEVICE, INFORMATION PROCESSING METHOD, AND COMPUTER READABLE MEDIUM

(71) Applicant: MITSUBISHI ELECTRIC CORPORATION, Tokyo (JP)

(72) Inventors: Naoyuki TSUSHIMA, Tokyo (JP); Masahiko TANIMOTO, Tokyo (JP); Masahiro ABUKAWA, Tokyo (JP)

(73) Assignee: MITSUBISHI ELECTRIC CORPORATION, Tokyo (JP)

(21) Appl. No.: 16/961,721

(22) PCT Filed: Mar. 5, 2018
(86) PCT No.: PCT/JP2018/008410

§ 371 Date: Jul. 13, 2020

(51) Int. Cl. G08G 1/16

(52) U.S. Cl. CPC G08G 1/165; G01S 13/931

(57) ABSTRACT

An information processing device is mounted on a movable body. A calculation unit acquires sensor data in which detection points are indicated, the detection points being acquired by scanning a periphery of a sensor by the sensor, the sensor being located at the periphery of the movable body, analyzes the acquired sensor data, and calculates a distribution range of the detection points. Based on the distribution range of the detection points calculated by the calculation unit, a removal unit extracts a detection point for the movable body from among the detection points indicated in the sensor data, and removes the extracted detection point for the movable body from the sensor data.

### TECHNICAL FIELD

The present invention relates to techniques for processing sensor data acquired by a sensor.

### BACKGROUND ART

From growing safety mind and quest for usability, vehicles equipped with a driving assist function such as an emergency automatic braking function have been increasing. To achieve the driving assist function, a sensor which emits electric waves or light such as a millimeter wave radar or LiDAR (Light Detection And Ranging) is used in some cases.

The sensor for achieving the driving assist function cannot sense an area covered with a shielding object or the like. Thus, for the area covered with a shielding object or the like, there is a method in which a vehicle equipped with the driving assist function (hereinafter referred to as a driving-assist-function-equipped vehicle) uses means called V2X (Vehicle to Everything) using communication to receive the detection results by a sensor mounted on another vehicle or an infrastructure facility.

However, if the sensor detection results received by the driving-assist-function-equipped vehicle include the driving-assist-function-equipped vehicle itself, the driving assist function may erroneously recognize that an object is present just next to the driving-assist-function-equipped vehicle, possibly leading to erroneous operation.

In Patent Literature 1, it is described that the driving assist function excludes the driving-assist-function-equipped vehicle from other vehicle object information.

### CITATION LIST

### Patent Literature

Patent Literature 1: JP 2008-293099

### SUMMARY OF INVENTION

### Technical Problem

In the technique of Patent Literature 1, if an error component is present in the other vehicle object information, there is a problem that it is difficult to correctly identify the driving-assist-function-equipped vehicle in the other vehicle object information and exclude the driving-assist-function-equipped vehicle from the other vehicle object information.

A main object of the present invention is to solve this problem.

Specifically, a main object of the present invention is to acquire a configuration in which, even if an error component is present in sensor data acquired by a sensor located at the periphery of a movable body, a detection point for the movable body can be correctly removed from the sensor data.

### Solution to Problem

An information processing device according to the present invention to be mounted on a movable body, the information processing device includes:

a calculation unit to acquire sensor data in which detection points are indicated, the detection points being acquired by scanning a periphery of a sensor by the sensor, the sensor being located at a periphery of the movable body, to analyze the acquired sensor data, and to calculate a distribution range of the detection points; and

a removal unit to extract, based on the distribution range of the detection points calculated by the calculation unit, a detection point for the movable body from among the detection points indicated in the sensor data, and to remove the extracted detection point for the movable body from the sensor data.

### Advantageous Effects of Invention

According to the present invention, even if an error component is present in sensor data, a detection point for the movable body can be correctly removed from the sensor data.

### BRIEF DESCRIPTION OF DRAWINGS

FIG. 1 is a diagram illustrating a hardware configuration example of an on-vehicle system according to Embodiment 1.

FIG. 2 is a diagram illustrating a hardware configuration example of an information processing device according to Embodiment 1.

FIG. 3 is a diagram illustrating a functional configuration example of the information processing device according to Embodiment 1.

FIG. 4 is a diagram illustrating an example of vehicle positions according to Embodiment 1.

FIG. 5 is a diagram illustrating an example of a vehicle position according to Embodiment 1.

FIG. 6 is a diagram illustrating an example of a sensing range according to Embodiment 1.

FIG. 7 is a diagram illustrating an example of a distribution range of detection points according to Embodiment 1.

FIG. 8 is a diagram illustrating an example of operation of the information processing device according to Embodiment 1.

FIG. 9 is a flowchart illustrating an example of operation of a calculation unit according to Embodiment 1.

FIG. 10 is a flowchart illustrating an example of operation of a removal unit according to Embodiment 1.

FIG. 11 is a diagram illustrating an example of operation of an information processing device according to Embodiment 2.

FIG. 12 is a flowchart illustrating an example of operation of a removal unit according to Embodiment 2.

### DESCRIPTION OF EMBODIMENTS

In the following, embodiments of the present invention are described by using the drawings. In the following description of the embodiments and the drawings, components provided with the same reference character indicate the same or corresponding portion.

### Embodiment 1

***Description of Configuration***

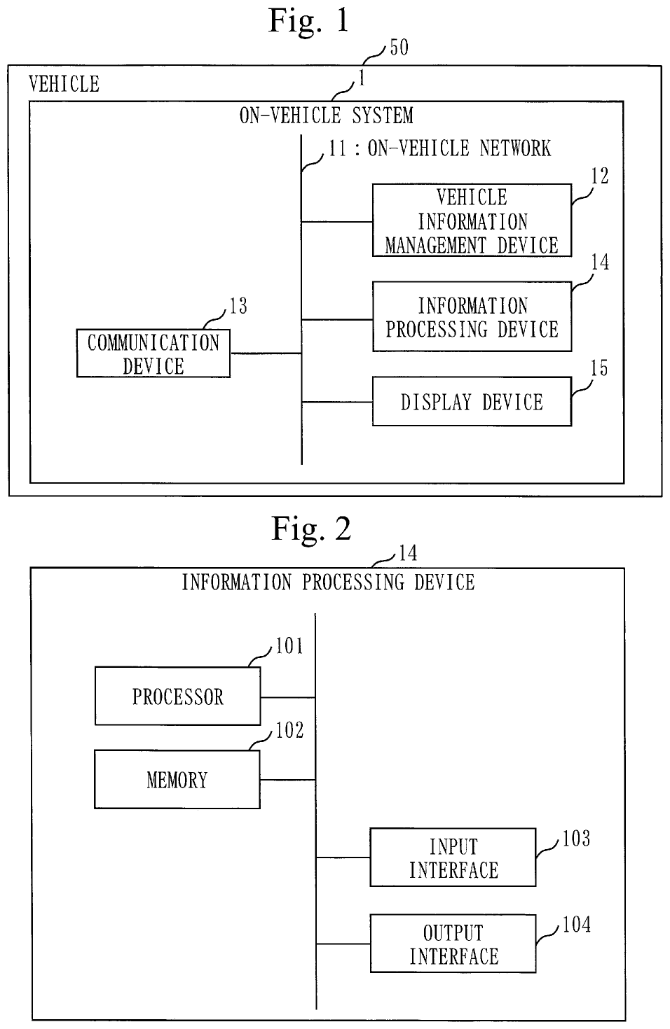

FIG. 1 illustrates a hardware configuration example of an on-vehicle system 1 according to the present embodiment.

The on-vehicle system 1 is mounted on a vehicle 50. The vehicle 50 is a driving-assist-function-equipped vehicle.

The on-vehicle system 1 is configured of an on-vehicle network 11, a vehicle information management device 12, a communication device 13, an information processing device 14, and a display device 15.

The on-vehicle network 11 is a network such as CAN (Control Area Network) or on-vehicle Ethernet (registered trademark).

The vehicle information management device 12 manages vehicle information of the vehicle 50. The vehicle information is, for example, information about the current position of the vehicle 50 and information about the velocity of the vehicle 50.

The communication device 13 communicates with another vehicle or a roadside device. The roadside device is an example of a stationary object disposed on a travel route of the vehicle 50.

The other vehicle or the roadside device is located at the periphery of the vehicle 50.

The information processing device 14 calculates an error component included in sensor data acquired from a sensor on the other vehicle or a sensor on the roadside device and, based on the calculated error component, removes a detection point for the vehicle 50 from the sensor data.

In the sensor data, detection points acquired by scanning the periphery by the sensor on the other vehicle or the sensor on the roadside device are indicated. The detection points will be described further below.

Note that operation performed by the information processing device 14 corresponds to an information processing method.

The display device 15 displays information to an occupant of the vehicle 50. The display device 15 is, for example, a display.

FIG. 2 illustrates a hardware configuration example of the information processing device 14.

The information processing device 14 is configured of a processor 101, a memory 102, an input interface 103, and an output interface 104.

The processor 101 reads and executes a program stored in the memory 102.

The program implements a calculation unit 141 and a removal unit 142, which will be described further below. Note that the program corresponds to an information processing program.

The processor 300 is, for example, a CPU (Central Processing Unit) or GPU (Graphical Processing Unit).

In the memory 102, the above-described program and various types of data are stored. Also, in the memory 102, sensor data of the sensor on the other vehicle or the roadside device is stored.

The memory 102 is, for example, a RAM (Ramdam Access Memory), HDD (Hard Disk Drive), or flash memory.

The input interface 103 acquires data from the vehicle information management device 12 or the communication device 13.

For example, the input interface 103 acquires sensor data of the sensor on the other vehicle or the sensor on the roadside device from the communication device 13.

The output interface 104 outputs to the display device 15, data in which the process results of the processor 101 are indicated.

For example, the output interface 104 outputs to the display device 15, sensor data after the detection point for the vehicle 50 is removed.

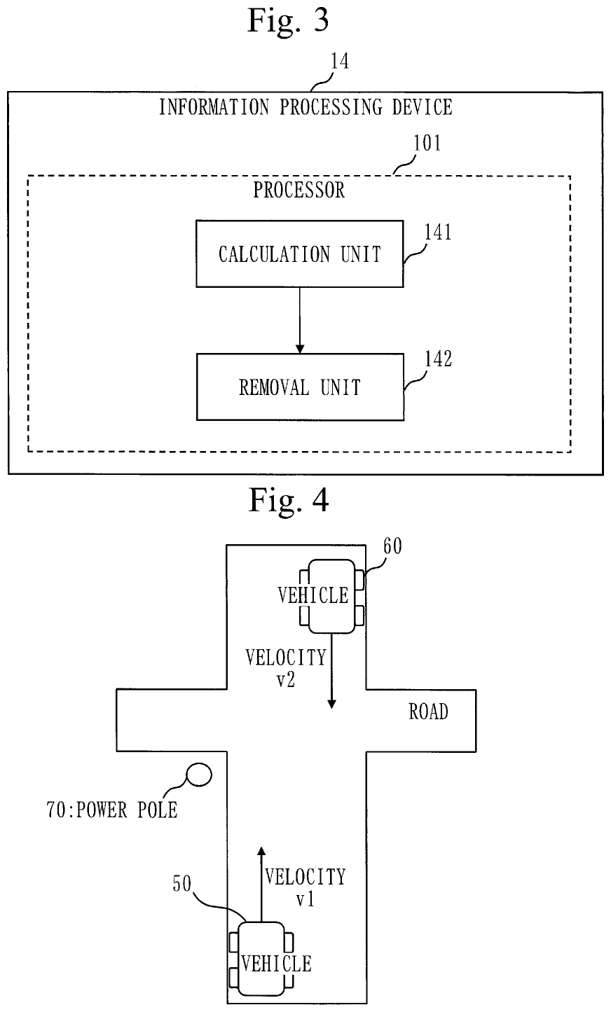

FIG. 3 illustrates a functional configuration example of the information processing device 14.

The information processing device 14 is configured of the calculation unit 141 and the removal unit 142.

Note that FIG. 3 schematically illustrates a state in which the processor 101 is executing a program which implements the calculation unit 141 and the removal unit 142.

The calculation unit 141 acquires, from the input interface 103, sensor data of the sensor on the other vehicle or the sensor on the roadside device. Then, the calculation unit 141 analyzes the acquired sensor data, and calculates a distribution range of detection points.

More specifically, the calculation unit 141 analyzes a plurality of pieces of sensor data in a time-series manner, and calculates a distribution range of detection points for the same stationary object in the plurality of pieces of sensor data.

Based on the distribution range of the detection points calculated by the calculation unit 141, the removal unit 142 extracts a detection point for the vehicle 50 from among the detection points indicated in the sensor data. More specifically, from among the detection points indicated in the sensor data, the removal unit 142 extracts, as a detection point for the vehicle 50, a detection point in the distribution range of the detection points calculated by the calculation unit 141 from the location position of the vehicle 50.

Then, the removal unit 142 removes the extracted detection point for the vehicle 50 from the sensor data.

***Description of Operation***

Next, an example of operation of the information processing device 14 according to the present embodiment is described.

FIG. 4 illustrates an example of positions of the vehicle 50 and another vehicle 60 according to the present embodiment.

In FIG. 4, the vehicle 50 is traveling at a velocity v1 . The vehicle 60 is traveling at a velocity v2 on an opposite lane toward the vehicle 50.

On a roadside of a road, which is a travel route of the vehicle 50 and the vehicle 60, a power pole 70 as a stationary object is arranged.

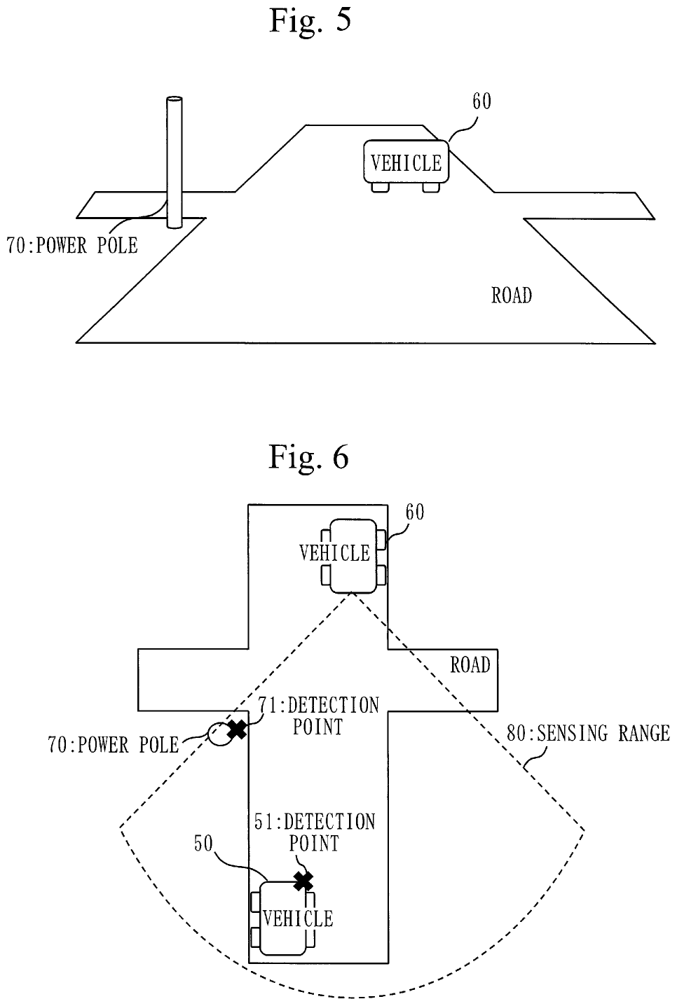

FIG. 5 illustrates a state viewed from the vehicle 50 to a direction of the vehicle 60 (forward).

On the vehicle 60, a sensor is disposed. The sensor on the vehicle 60 is, for example, a millimeter-wave radar or LiDAR. The sensor on the vehicle 60 scans its periphery. That is, the sensor on the vehicle 60 irradiates its periphery with electric waves or laser and acquires its reflection, thereby detecting the presence or absence of an obstacle.

FIG. 6 illustrates a sensing range 80 of the sensor on the vehicle 60 and detection points.

The sensor is attached to the front surface of the vehicle 60. As illustrated in FIG. 6, the sensing range 80 having a fan shape can be acquired.

A pivotal portion of the fan shape is a sensor attachment position, from which irradiation with electric waves or laser is radially made.

When reflected from an object, the electric waves or laser forms a reflection point. Due to the structure of the sensor, the reflection point is present in a range to which electric waves or laser reaches, and no reflection point is present on the back of the object where electric waves or laser does not reach. A strongly-reflective reflection point is typically a corner of the object or a point near the sensor. This typical reflection point is referred to as a detection point.

In the example of FIG. 6, a detection point 51 is present on the vehicle 50, and a detection point 71 is present on the power pole 70.

In the vehicle 60, vehicle data and sensor data are wirelessly transmitted by a communication device mounted on the vehicle 60.

In the vehicle data, the position, velocity, and traveling direction of the vehicle 60 are indicated.

In the sensor data, an obstacle ID is indicated, which is an ID (Identifier) of an object (hereinafter referred to as an obstacle) for which a detection point is detected. Also, the position, velocity, and traveling direction of the detection point are indicated in association with the obstacle ID.

As for the obstacle ID indicated in the sensor data, the same obstacle ID is provided to an object determined by a computer mounted on the vehicle 60 as the same obstacle from the position of the detection point.

Furthermore, the position of the detection point indicated in the sensor data may be an absolute position such as the latitude and longitude of the detection point or a relative position centering at the center point of the vehicle 60 or the sensor.

Still further, if the vehicle 60 can only transmit information about the position, the information processing device 14 included in the vehicle 50 may perform time-series processing on positions reported from the vehicle 60 and calculate the velocity and traveling direction of the vehicle 60 and the detection point.

Wireless communication between the vehicle 60 and the vehicle 50 is assumed to be by IEEE 802.11p, but may be of any scheme capable of transmitting and receiving vehicle data and sensor data.

In the vehicle 60, scanning by the sensor and transmission of vehicle data and sensor data by the communication device are repeatedly performed.

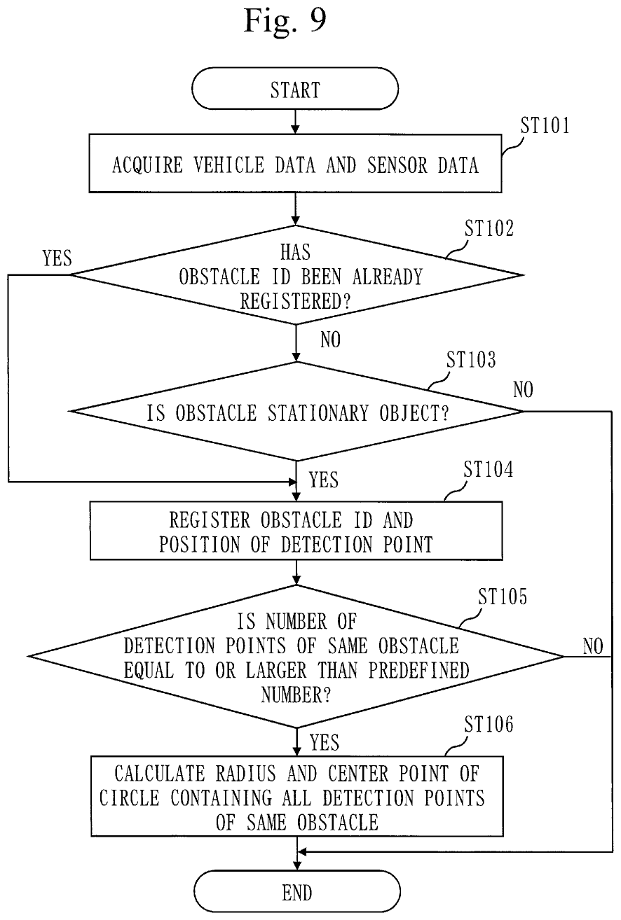

Next, by using a flowchart of FIG. 9, an example of operation of the calculation unit 141 is described.

The process of FIG. 9 is performed every time the communication device 13 receives vehicle data and sensor data from the vehicle 60.

At step ST101, the calculation unit 141 acquires vehicle data and sensor data transmitted from the vehicle 60 via the communication device 13 and the input interface 130.

Also, if positions indicated in the vehicle data and the sensor data are relative positions, the calculation unit 141 converts the positions indicated in the vehicle data and the sensor data to absolute coordinates.

Next, at step ST103, the calculation unit 141 determines whether the obstacle ID indicated in the sensor data has been already registered in the memory 102.

If the obstacle ID has been already registered in the memory 102, the process proceeds to step ST104. On the other hand, if the obstacle ID has not been registered in the memory 102, the process proceeds to step ST105.

At step ST103, the calculation unit 141 determines whether the obstacle indicated in the sensor data as an obstacle ID is a stationary object. Specifically, the calculation unit 141 determines, from the velocity and the traveling direction associated with the obstacle ID, whether the state is such that the obstacle is moving toward the vehicle 60 at the traveling velocity of the vehicle 60 indicated in the vehicle data. If the state is such that the obstacle is moving toward the vehicle 60 at the traveling velocity of the vehicle 60, the calculation unit 141 determines that the obstacle is a stationary object.

If the obstacle is a stationary object, the process proceeds to step ST104. On the other hand, if the obstacle is not a stationary object, the process ends.

At step ST104, the calculation unit 141 registers the obstacle ID and the position of the corresponding detection point in the memory 102.

At step ST105, the calculation unit 141 refers to the memory 102 to determine whether the number of detection points of the same obstacle is equal to or larger than a predefined number. The predefined number is two or more. The predefined number is desirably five or more.

If the number of detection points of the same obstacle is equal to or larger than the predefined number, the process proceeds to step ST106. On the other hand, if the number of detection points of the same obstacle is smaller than the predefined number, the process ends.

At step ST106, the calculation unit 141 calculates the radius and the center point of a circle containing all detection points of the same obstacle.

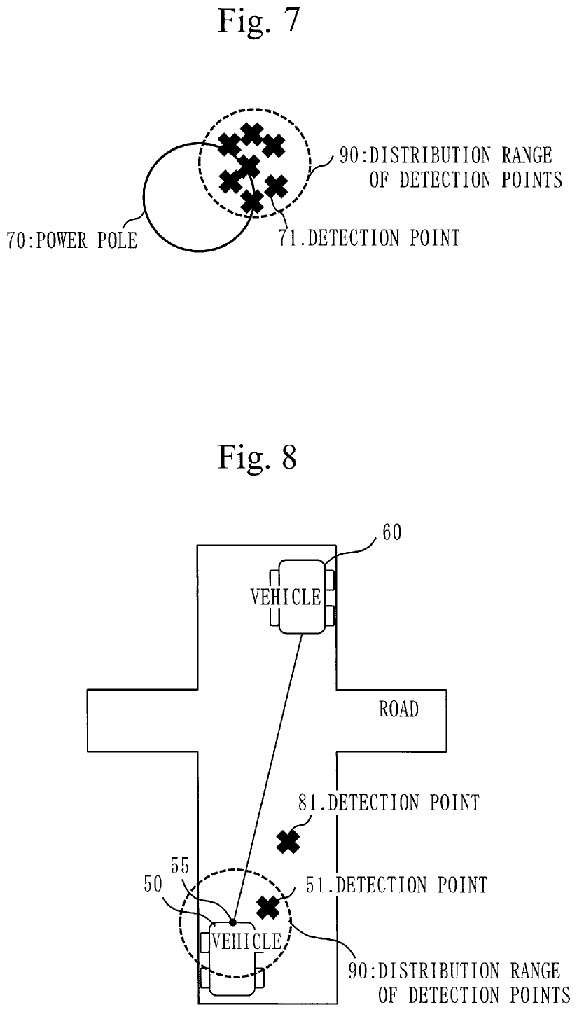

For example, as illustrated in FIG. 7, assume that seven detection points 71 are present for the power pole 70. In this example, from seven pieces of sensor data, seven detection points 71 have been acquired for the power pole 70.

The calculation unit 41 calculates the radius and the center point of a circle resulting in containing the seven detection points 71.

This circle containing a plurality of detection points corresponds to a distribution range of the detection points. That is, at step ST106, the calculation unit 141 calculates a distribution range of the detection points for the same stationary object.

In the example of FIG. 7, a circle denoted as a reference numeral 90 is a distribution range of the detection points 71 of the power pole 70.

Note that a detection point that is associated with the same obstacle ID but is at a position clearly different from those of other detection points is excluded from calculation of a distribution range. The calculation unit 141 excludes, from calculation of a distribution range, for example, a detection point at a position greatly diverging from the size of an object that can be present on a roadside, such as a detection point two meters or more away from other detection points.

The calculation unit 141 outputs the calculated radius and center point of the circle to the removal unit 142 as obstacle error distribution range information. Also, the calculation unit 141 outputs the latest vehicle data and the latest sensor data to the removal unit 142.

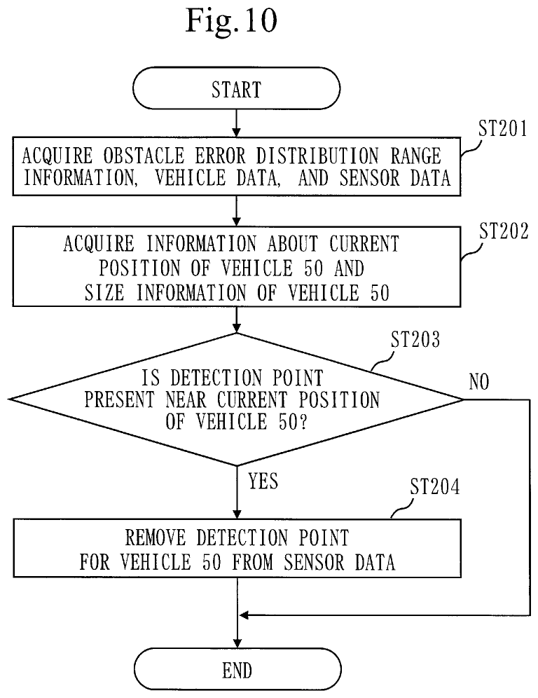

Next, by using a flowchart of FIG. 10, an example of operation of the removal unit 142 is described.

The process of FIG. 10 is performed every time the obstacle error distribution range information, the latest vehicle data, and the latest sensor data are outputted from the calculation unit 141.

At step ST201, the removal unit 142 acquires the obstacle error distribution range information, the vehicle data, and the sensor data from the calculation unit 141.

Next, at step ST202, the removal unit 142 acquires information about the current position of the vehicle 50 and size information of the vehicle 50.

For example, the removal unit 142 acquires information about the current position of the vehicle 50 from the vehicle information management device 12.

Also, the removal unit 142 acquires the size information of the vehicle 50 from the memory 102. Note that, once acquired, the size information of the vehicle 50 is not required to be acquired again.

Next, at step S203, the removal unit 142 determines whether a detection point is present near the current position of the vehicle 50, that is, a detection point of the vehicle 50 is included in the sensor data.

Specifically, first, the removal unit 142 finds a point of intersection of a line segment connecting the vehicle 60 and the vehicle 50 and the outer shape of the vehicle 50. The outer shape of the vehicle 50 is acquired from the current position and the size information of the vehicle 50 acquired at step S202.

Next, the removal unit 142 calculates a circle having the radius reported in the obstacle error distribution range information and centering at the point of intersection of the line segment connecting the vehicle 60 and the vehicle 50 and the outer shape of the vehicle 50. The range of this circle corresponds to the distribution range 90 of the detection points illustrated in FIG. 7.

Next, the removal unit 142 determines whether a detection point included in the range of the calculated circle is present in the sensor data.

The detection point included in the range of the circle is a detection point for the vehicle 50.

The process at step S203 is described by using FIG. 8.

In FIG. 8, a point denoted by a reference numeral 55 is the point of intersection of the line segment connecting the vehicle 60 and the vehicle 50 and the outer shape of the vehicle 50.

The circle of the distribution range 90 of the detection points is similar to that illustrated in FIG. 7. Note in FIG. 8 that, for ease of understanding, the distribution range 90 of the detection points is rendered as being larger than the actual size.

And, in FIG. 8, the detection point 51 is included in the circle of the distribution range 90 of the detection points centering at a point of intersection 55.

On the other hand, a detection point 81 is not included in the circle of the distribution range 90 of the detection points centering at the point of intersection 55.

Thus, in the determination at step S203, the determination is true for the detection point 51, and the determination is false for the detection point 81.

Note that while the line segment connecting the centers of the vehicle 50 and the vehicle 60 is drawn in the example of FIG. 8, if the attachment position of the sensor in the vehicle 60 is known, accuracy can be improved by using a line segment connecting the attachment position of the sensor in the vehicle 60 and the vehicle 50.

Next, at step ST204, the removal unit 142 removes the detection point determined as true at step ST203 from the sensor data.

In the example of FIG. 8, the removal unit 142 removes the detection point 51 from the sensor data.

The detection point 51 is included in the circle of the distribution range 90 of the detection points from the point of intersection 55, and is thus considered as a detection point for the vehicle 50 including an error component.

In the above, the example has been described in which the detection point of the vehicle 50 is removed from the sensor data acquired by the sensor set in the vehicle 60 as a movable body. The detection point of the vehicle 50 can also be removed from the sensor data acquired by the sensor set in the roadside device by applying the procedure illustrated in FIG. 9 and FIG. 10 to the sensor data acquired by the sensor set in the roadside device.

***Description of Effects of Embodiment***

As described above, in the present embodiment, even if an error component is present in the sensor data, the detection point for the vehicle 50 can be correctly removed from the sensor data.

That is, in the present embodiment, the information processing device 14 calculates, as an error distribution range, the distribution range 90 of the detection points for the same stationary object, and extracts a detection point in the distribution range 90 calculated from the location position of the vehicle 50 as a detection point of the vehicle 50.

Thus, the detection point for the vehicle 50 can be correctly removed from the sensor data without recognizing the error characteristics of the sensor set in the vehicle 60 or the sensor set in the roadside device in advance.

Embodiment 2.

In Embodiment 1, the detection point for the vehicle 50 is removed from the sensor data by using the position information of the detection point. However, in the scheme of Embodiment 1, there is a possibility that if an object is actually present near the vehicle 50, the detection point of that object is recognized as a detection point of the vehicle 50 and removed.

Thus, in the present embodiment, a configuration is described in which only the detection point of the vehicle 50 can be extracted with higher accuracy based on a relative velocity between the vehicle 50 and the sensor.

In the present embodiment, differences from Embodiment 1 are mainly described.

Note that matters not described below are the same as those in Embodiment 1.

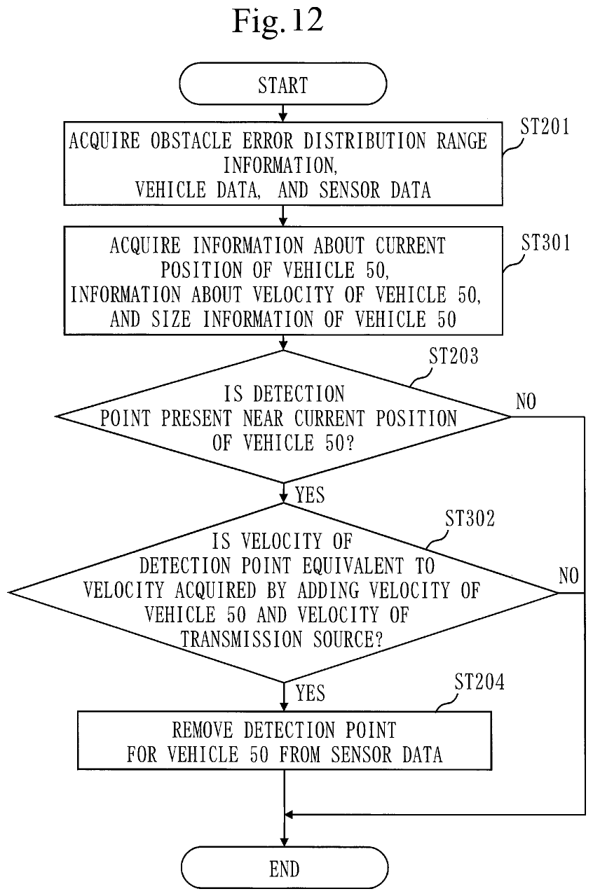

By using a flowchart of FIG. 12, an example of operation of the removal unit 142 according to the present embodiment is described.

Since steps ST201, ST203, and ST204 are identical to those illustrated in FIG. 10, description is omitted.

At step ST301, the removal unit 142 acquires information about the current position of the vehicle 50, information about the velocity of the vehicle 50, and size information of the vehicle 50.

At step ST302, the removal unit 142 determines whether the velocity of the detection point determined as true at S203 is equivalent to a value acquired by adding the velocity of the vehicle 50 and the velocity of the transmission source (vehicle 60) of the sensor data.

For example, the removal unit 142 determines that the velocity is equivalent to the value if a velocity difference between the velocity of the detection point determined as true at step S203 and the value acquired by adding the velocity of the vehicle 50 and the velocity of the transmission source (vehicle 60) of the sensor data is within 10%.

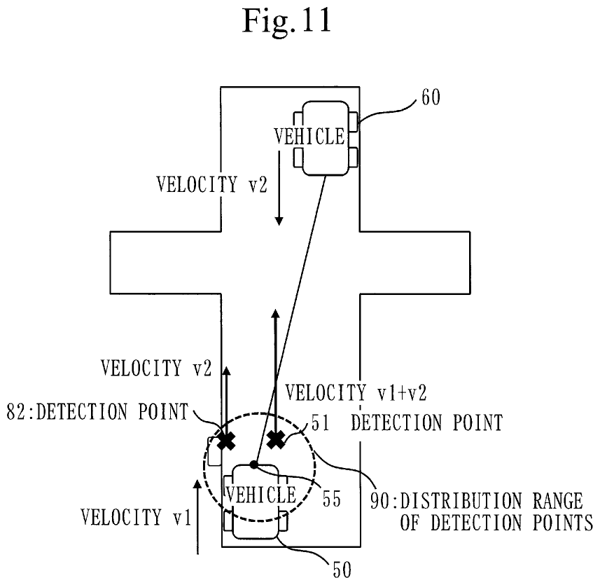

The process at step S302 is described by using FIG. 11.

In FIG. 11, it is assumed that the vehicle 50 travels at a velocity v1, and the vehicle 60 travels at a velocity v2.

Also, the detection point 51 and a detection point 82 are both included in the circle of the distribution range 90 of the detection points.

In the example of FIG. 11, the velocity of the detection point 51 is a relative velocity v1+v2 acquired by adding the velocity v1 of the vehicle 50 and the velocity v2 of the vehicle 60. On the other hand, the velocity of the detection point 82 is the velocity v2 of the vehicle 60.

Since the vehicle 60 travels at the velocity v2, it is sensed in the vehicle 60 that the vehicle 50 is coming toward the vehicle 60 at the velocity v1+v2. On the other hand, in the case of a stationary object, it is sensed in the vehicle 60 that the object is coming toward the vehicle 60 at the velocity v2.

Thus, in the determination at step S302, the determination is true for the detection point 51, and the determination is false for the detection point 82. That is, the detection point 51 is a detection point for the vehicle 50, and the detection point 82 is a detection point for a stationary object near the vehicle 50.

At step ST204, the removal unit 142 removes the detection point determined as true at step ST302 from the sensor data.

In the example of FIG. 11, the removal unit 142 removes the detection point 51 from the sensor data.

In the above, the example has been described in which the detection point of the vehicle 50 is removed from the sensor data acquired by the sensor set in the vehicle 60 as a movable body. The detection point of the vehicle 50 can also be removed from the sensor data acquired by the sensor set in the roadside device by applying the procedure illustrated in FIG. 12 to the sensor data acquired by the sensor set in the roadside device. In this case, the velocity of the roadside device is zero, the removal unit 142 makes a determination at step S302 by setting the velocity of the transmission source of the sensor data at zero.

***Description of Effects of Embodiment***

As described above, in the present embodiment, by using the velocities, it is determined whether each detection point is a detection point for the vehicle 50 or a detection point for another object. Thus, according to the present embodiment, even if an object other than the vehicle 50 is present near the vehicle 50, the detection point for the vehicle 50 can be more correctly removed from the sensor data, compared with Embodiment 1.

In the above-described Embodiment 1 and Embodiment 2, the example has been described which uses the sensor data of the sensor attached to the front surface of the vehicle 60 traveling in the direction facing the vehicle 50. Furthermore, the procedure described in Embodiment 1 or Embodiment 2 may be applied to sensor data of a sensor attached to the back surface of a vehicle traveling ahead of the vehicle 50 to the same traveling direction as that of the vehicle 50. The procedure described in Embodiment 1 or Embodiment 2 may also be applied to sensor data of a sensor attached to the front surface of a vehicle traveling behind the vehicle 50 to the same traveling direction as that of the vehicle 50.

Also, in the above-described Embodiment 1 and Embodiment 2, description has been made by taking the information processing device 14 mounted on the vehicle 50 as an example. Alternatively, the information processing device 14 may be mounted on another movable body, for example, a ship, a train, or the like.

While the embodiments of the present invention have been described in the foregoing, these two embodiments may be combined for implementation.

Alternatively, of these two embodiments, one may be partially implemented.

Alternatively, these two embodiments may be partially combined for implementation.

Note that the present invention is not limited to these embodiments and can be variously changed as required.

***Description of Hardware Configuration***

Lastly, supplementary description of the hardware configuration of the information processing device 14 is made.

In the memory 102, an OS (Operating System) is also stored.

And, at least part of the OS is executed by the processor 101.

While executing at least part of the OS, the processor 101 executes the program implementing the functions of the calculation unit 141 and the removal unit 142.

With the processor 101 executing the OS, task management, memory management, file management, communication control, and so forth are performed.

Also, at least any of the information, data, signal values, and variable values indicating the results of processes of the calculation unit 141 and the removal unit 142 is stored in at least any of the memory 102 and a register and a cache memory of the processor 101.

Also, the program implementing the functions of the calculation unit 141 and the removal unit 142 may be stored in a portable recording medium such as a magnetic disc, flexible disc, optical disc, compact disc, Blu-ray (registered trademark) disc, or DVD.

Also, the “units” of the calculation unit 141 and the removal unit 142 may be read as “circuits”, “steps”, “procedures”, or “processes”.

Also, the information processing device 14 may be implemented by a processing circuit. The processing circuit is, for example, a logic IC (Integrated Circuit), GA (Gate Array), ASIC (Application Specific Integrated Circuit), or FPGA (Field-Programmable Gate Array).

Note that in the present specification, a superordinate concept of the processor 101, the memory 102, a combination of the processor 101 and the memory 102, and the processing circuit is referred to as “processing circuitry”.

That is, each of the processor 101, the memory 102, a combination of the processor 101 and the memory 102, and the processing circuit is a specific example of the “processing circuitry”.

### REFERENCE SIGNS LIST

1: on-vehicle system; 11: on-vehicle network; 12: vehicle information management device; 13: communication device; 14: information processing device; 15: display device; 50: vehicle; 51: detection point; 60: vehicle; 70: power pole; 71: detection point; 80: sensing range; 90: distribution range of detection points; 101: processor; 102: memory; 103: input interface; 104: output interface; 141: calculation unit; 142: removal unit

1. An information processing device to be mounted on a movable body, the information processing device comprising:
processing circuitry:
to acquire a plurality of pieces of sensor data in which detection points are indicated, the detection points being acquired by scanning a periphery of a sensor by the sensor, the sensor being located at a periphery of the movable body, to analyze the plurality of pieces of sensor data acquired, and to calculate a distribution range of the detection points for a same stationary object in the plurality of pieces of sensor data; and
to extract, based on the distribution range of the detection points calculated, a detection point for the movable body from among the detection points indicated in the plurality of pieces of sensor data, and to remove the extracted detection point for the movable body from the plurality of pieces of sensor data.

2. (canceled)

3. The information processing device according to claim 1, wherein
the processing circuitry extracts,
as the detection point for the movable body, a detection point in the calculated distribution range of the detection points from a location position of the movable body from among the detection points indicated in the sensor data.

4. The information processing device according to claim 1, wherein
the processing circuitry extracts
the detection point for the movable body from among the detection points indicated in the sensor data based on the calculated distribution range of the detection points and a relative velocity between the movable body and the sensor.

5. The information processing device according to claim 1, wherein
the processing circuitry acquires at least either of sensor data in which detection points are indicated, the detection points being acquired by scanning a periphery of a sensor by the sensor, the sensor being set in another movable body traveling on a travel route of the movable body, and sensor data in which detection points are indicated, the detection points being acquired by scanning a periphery of a sensor by the sensor, the sensor being set in a stationary object disposed on the travel route, analyzes the acquired sensor data, and calculates the distribution range of the detection points.

6. An information processing method to be performed by a computer to be mounted on a movable body, the information processing method comprising:
by the computer, acquiring a plurality of pieces of sensor data in which detection points are indicated, the detection points being acquired by scanning a periphery of a sensor by the sensor, the sensor being located at a periphery of the movable body, analyzing the plurality of pieces of sensor data acquired, and calculating a distribution range of the detection points for a same stationary object in the plurality of pieces of sensor data; and
by the computer, extracting, based on the calculated distribution range of the detection points, a detection point for the movable body from among the detection points indicated in the plurality of pieces of sensor data, and removing the extracted detection point for the movable body from the plurality of pieces of sensor data.

7. A non-transitory computer readable medium storing an information processing program that causes a computer to be mounted on a movable body to execute:
a calculation process of acquiring a plurality of pieces of sensor data in which detection points are indicated, the detection points being acquired by scanning a periphery of a sensor by the sensor, the sensor being located at a periphery of the movable body, analyzing the plurality of pieces of sensor data acquired, and calculating a distribution range of the detection points for a same stationary object in the plurality of pieces of sensor data; and
a removal process of extracting, based on the distribution range of the detection points calculated by the calculation process, a detection point for the movable body from among the detection points indicated in the plurality of pieces of sensor data, and removing the extracted detection point for the movable body from the plurality of pieces of sensor data.
